(19) United States
(12) Patent Application Publication
(10) Pub. No.: US 2016/0097534 A1
(43) Pub. Date: Apr. 7, 2016

(54) Toxic Gas Expelling Assembly

(71) Applicant: Ryan De Vries, Paisley (CA)

(72) Inventor: Ryan De Vries, Paisley (CA)

(21) Appl. No.: 14/504,617

(22) Filed: Oct. 2, 2014

(51) Int. Cl. F23N 5/24; G08B 21/14; F24F 11/00

(52) U.S. Cl. CPC F23N 5/242; F24F 11/0017; G08B 21/14; F24F 2011/0027

(57) ABSTRACT

A toxic gas expelling assembly for detecting and eliminating a toxic gas from a structure includes a furnace structured to provide heated air in the structure. A ventilator is provided. The ventilator is structured to selectively ventilate air in the structure. A housing is positioned within the structure. A processor is coupled to the housing. The processor is electrically coupled to the furnace and the ventilator. The processor is in communication with emergency services. A sensor is coupled to the housing and the processor. The sensor may detect a level of toxic gas in the structure. The processor disables the furnace and actuates the ventilator if the sensor detects a trigger amount of the toxic gas in the structure. The processor contacts the emergency services when the sensor detects the trigger amount of toxic gas. The ventilator urges the toxic gas and ambient air outwardly of the structure.

### BACKGROUND OF THE DISCLOSURE

### Field of the Disclosure

The disclosure relates to expelling devices and more particularly pertains to a new expelling device for detecting and expelling a toxic gas from a structure.

### SUMMARY OF THE DISCLOSURE

An embodiment of the disclosure meets the needs presented above by generally comprising a furnace structured to provide heated air in a structure. A ventilator is provided. The ventilator is structured to selectively ventilate air in the structure. A housing is positioned within the structure. A processor is coupled to the housing. The processor is electrically coupled to the furnace and the ventilator. The processor is additionally in communication with emergency services. A sensor is coupled to the housing. The sensor is electrically coupled to the processor. The sensor may detect a level of toxic gas in the structure. The processor disables the furnace and actuates the ventilator if the sensor detects a trigger amount of the toxic gas in the structure. The processor notifies the emergency services of the presence of the toxic gas. The ventilator urges the toxic gas and ambient air outwardly of the structure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a alarm assembly according to an embodiment of the disclosure.

FIG. 2 is a front view of an embodiment of the disclosure.

FIG. 3 is a back view of an embodiment of the disclosure.

FIG. 4 is a schematic view of an embodiment of the disclosure.

FIG. 5 is an in-use view of an embodiment of the disclosure.

### DESCRIPTION OF THE PREFERRED EMBODIMENT

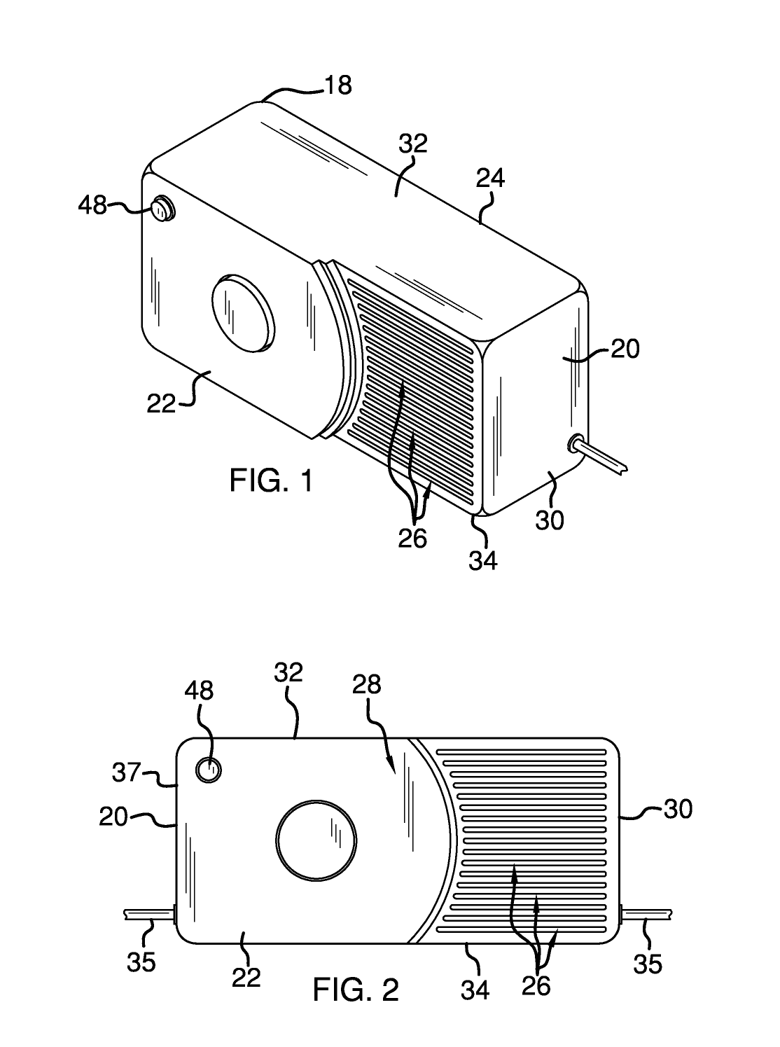

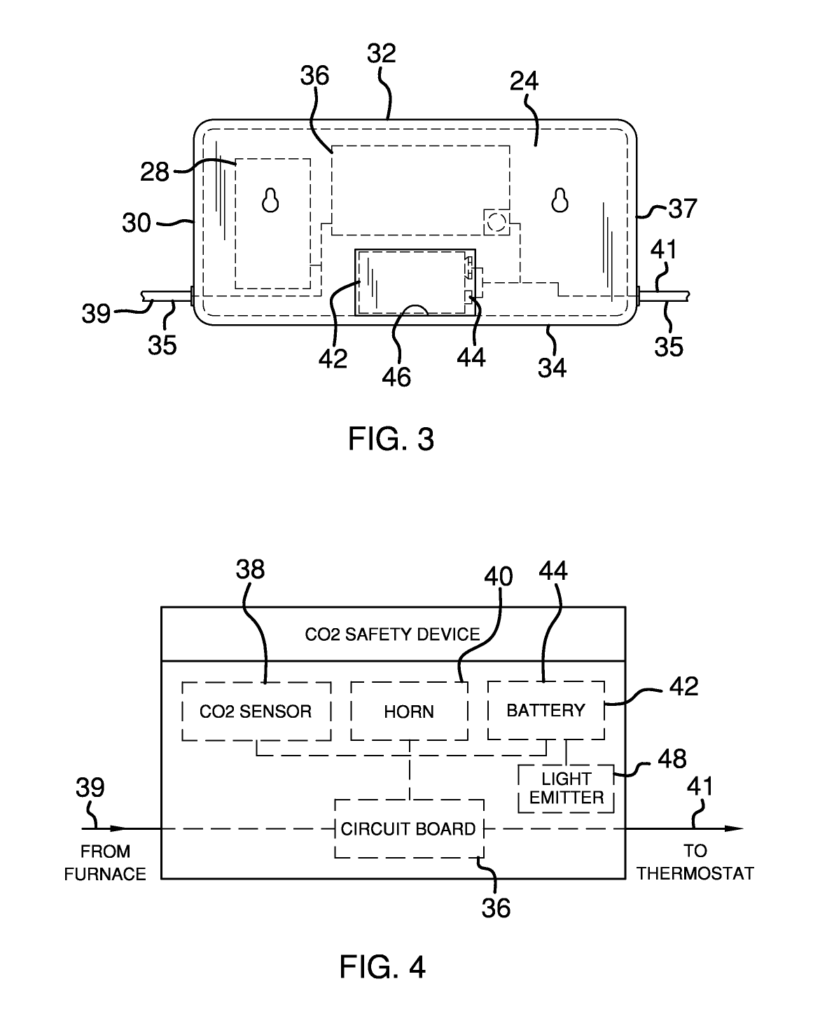

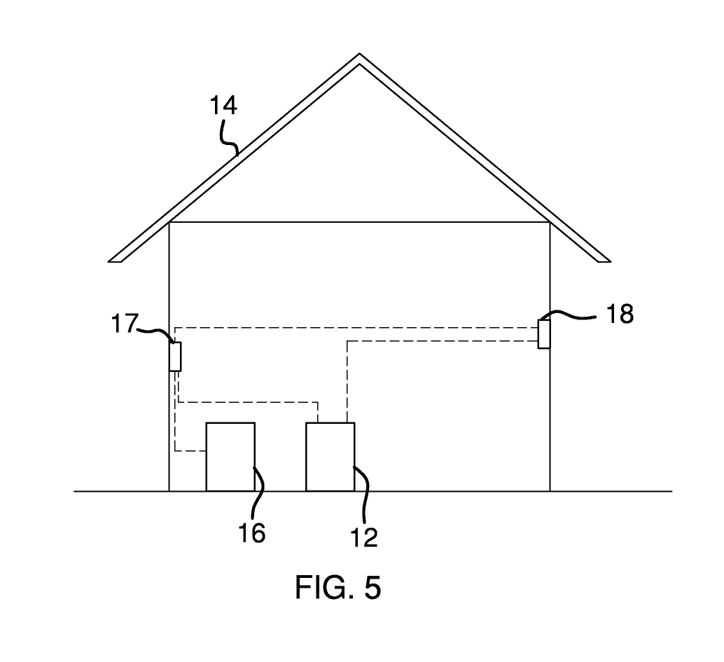

With reference now to the drawings, and in particular to FIGS. 1 through 5 thereof, a new expelling device embodying the principles and concepts of an embodiment of the disclosure and generally designated by the reference numeral 10 will be described.

As best illustrated in FIGS. 1 through 5, the toxic gas expelling assembly 10 generally comprises a furnace 12 structured to provide heated air in a structure 14. The furnace 12 may be a gas fired, forced air furnace of any conventional design. Additionally, the structure 14 may be a residential structure of any conventional design. A ventilator 16 is provided. The ventilator 16 is structured to selectively ventilate air in the structure 14. The ventilator 16 may be a heat recovery ventilator of any conventional design.

A thermostat 17 is positioned within in the structure 14. The thermostat 17 is electrically coupled to the furnace 12 and the ventilator 16. The thermostat 17 selectively actuates and de-actuates the furnace 12 and the ventilator 16.

A housing 18 is provided. The housing 18 has an outer wall 20 extending between each of a front wall 22 and a back wall 24 of the housing 18. The housing 18 is positioned within the structure 14. The front wall 22 of the housing 18 has a plurality of vents 26 extending therethrough so air may enter an interior of the housing 18. The vents 26 extend between a middle 28 of the front wall 24 of the housing 18 and a first lateral side 30 of the outer wall 20 of the housing 18. Additionally, the vents 26 are evenly distributed between a top side 32 and a bottom side 34 of the outer wall 20 of the housing 18.

A processor 36 is coupled to the housing 18. The processor 36 is electrically coupled to the furnace 12 and the ventilator 16. The processor 36 may be an electronic processor of any conventional design. The processor 36 is in communication with emergency services 33 through a hard line, a wireless network or the like. A sensor 38 is coupled to the housing 18. The sensor 38 is positioned proximate the plurality of vents 26 so the sensor 38 is exposed to the air entering the interior of the housing 18. The sensor 38 may be a carbon monoxide sensor of any conventional design.

The sensor 38 is electrically coupled to the processor 36. The sensor 38 detects a level of toxic gas in the structure 14. The toxic gas may be carbon monoxide. Additionally, the trigger amount of the carbon monoxide in the structure 14 may be between 35 ppm and 75 ppm.

A pair of conductors 35 is provided. Each of the conductors 35 extends outwardly from an associated one of the first lateral side 30 and a second lateral side 37 of the outer wall 20 of the housing 18. A first one 39 of the conductors 40 is electrically coupled to the furnace 12. A second one 41 of the conductors 35 is coupled to a thermostat 17. The processor interrupts communication between the thermostat and the furnace when the sensor detects the trigger amount of toxic gas in the structure. The processor 36 disables the furnace 12 and actuates the ventilator 16 when the sensor 38 detects the trigger amount of a toxic gas in the structure 14. The ventilator 16 urges the toxic gas and ambient air outwardly of the structure 14. Additionally, the processor 36 notifies the emergency services 33 of the presence of the toxic gas.

A horn 40 is provided. The horn 40 is coupled to the front wall 24 of the housing 18. The horn 40 is electrically coupled to the processor 36. Moreover, the horn 40 may be a sound emitting horn of any conventional design. The horn 40 emits an audible alarm when the sensor 38 detects the trigger amount of the toxic gas in the structure 14.

A power supply 42 is coupled to the housing 18. The power supply 42 is electrically coupled to the processor 36. The power supply 42 comprises at least one battery 44. A battery cover 46 is removably coupled to the back wall 24 of the housing 18. The power supply 42 is positioned beneath the battery cover 46.

A light emitter 48 is coupled to the front wall 22 of the housing 18. The light emitter 48 is electrically coupled to the processor 36. The light emitter 48 emits light to indicate the power supply 42 is operating properly. Additionally, the power supply 42 may be replaced when the light emitter 48 ceases to emit light.

In use, the furnace 12 is disabled when the sensor 38 detects the trigger amount of the toxic gas. The processor 36 prevents the furnace 12 from imparting any additional toxic gas in the structure through the combustion of a hydrocarbon fuel. The ventilator 16 continuously ventilates the air in the structure 14 until the sensor 38 detects a level of the toxic gas that is below the trigger amount. Additionally, the

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A toxic gas expelling assembly comprising:
a furnace structured to provide heated air in a structure;
a ventilator structured to selectively ventilate air in said structure;
a housing positioned within said structure;
a processor coupled to said housing, said processor being electrically coupled to said furnace and said ventilator, said processor being in communication with emergency services; and
a sensor coupled to said housing, said sensor being electrically coupled to said processor, said sensor being configured to detect a level of toxic gas in said structure, said processor disabling said furnace and actuating said ventilator when said sensor detects a trigger amount of toxic gas in said structure wherein said ventilator urges the toxic gas and ambient air outwardly of said structure, said processor contacting the emergency services when said sensor detects the trigger amount of toxic gas.

2. The assembly according to claim 1, further comprising said housing having an outer wall extending between each of a front wall and a back wall of said housing, said front wall of said housing having a plurality of vents extending therethrough such that air may enter an interior of said housing.

3. The assembly according to claim 2, further comprising said sensor being positioned proximate said plurality of vents such that said sensor is exposed to the air entering said interior of said housing.

4. The assembly according to claim 1, further comprising a horn coupled to said housing, said horn being electrically coupled to said processor, said horn emitting an audible alarm when said sensor detects the trigger amount of the toxic gas in the structure.

5. The assembly according to claim 1, further comprising a thermostat positioned in said structure, said thermostat being electrically coupled to said furnace such that said thermostat selectively actuates and de-actuates said furnace.

6. The assembly according to claim 5, further comprising a pair of conductors electrically coupled to said processor, a first one of said conductors being electrically coupled to said furnace, a second one of said conductors being electrically coupled to said thermostat such that said processor interrupts communication between said thermostat and said furnace when said sensor detect the trigger amount of toxic gas in said structure wherein said furnace is disabled.

7. The assembly according to claim 1, further comprising a power supply coupled to said housing, said power supply being electrically coupled to said processor, said power supply comprising at least one battery.

8. A toxic gas expelling assembly comprising:
a furnace structured to provide heated air in a structure;
a ventilator structured to selectively ventilate air in said structure;
a thermostat positioned in said structure, said thermostat being electrically coupled to said furnace and said ventilator such that said thermostat selectively actuates and de-actuates said furnace and said ventilator;
a housing, said housing having an outer wall extending between each of a front wall and a back wall of said housing, said housing being positioned within said structure;
said front wall of said housing having a plurality of vents extending therethrough such that air may enter an interior of said housing;
a processor coupled to said housing, said processor being electrically coupled to said furnace and said ventilator, said processor being in communication with emergency services;
a sensor coupled to said housing, said sensor being positioned proximate said plurality of vents such that said sensor is exposed to the air entering said interior of said housing, said sensor being electrically coupled to said processor, said sensor being configured to detect a level of toxic gas in the structure;
a pair of conductors electrically coupled to said processor, a first one of said conductors being electrically coupled to said furnace, a second one of said conductors being electrically coupled to said thermostat such that said processor interrupts communication between said thermostat and said furnace when said sensor detect the trigger amount of toxic gas in said structure wherein said furnace is disabled, said processor actuating said ventilator and contacting the emergency services when said sensor detects the trigger amount of the toxic gas in the structure wherein said ventilator urges the toxic gas and ambient air outwardly of the structure;
a horn coupled to said housing, said horn being electrically coupled to said processor, said horn emitting an audible alarm when said sensor detects the trigger amount of the toxic gas in the structure; and
a power supply coupled to said housing, said power supply being electrically coupled to said processor, said power supply comprising at least one battery.
